(19) United States
(12) Patent Application Publication
(10) Pub. No.: US 2026/0310710 A1
(43) Pub. Date: Oct. 8, 2026

(54) RELEVANCE SORTING FOR REVIEWS

(71) Applicant: Airbnb, Inc., San Francisco, CA (US)

(72) Inventor: Josefina Oria, San Francisco, CA (US)

(21) Appl. No.: 19/173,653

(22) Filed: Apr. 8, 2025

Related U.S. Application Data
(60) Provisional application No. 63/632,205, filed on Apr. 10, 2024.

(51) Int. Cl. G06F 16/35; G06F 16/3332

(52) U.S. Cl. CPC G06F 16/35; G06F 16/3334

(57) ABSTRACT

A method extracts, using a large language model (LLM), from a first natural language review of a property listed on a property reservation platform, a plurality of keywords. A method groups, by performing a cluster analysis on numerical representations of the keywords, the keywords into topics. A method generates, using the topics, a comprehensiveness score of the first natural language review. A method generates an overall score, including the comprehensiveness score, of natural language reviews of the property. A method displays, in a display of the property on the property reservation platform, a subset of the natural language reviews of the property ranked according to the overall score of each review in the plurality of natural language reviews.

### CROSS-REFERENCE OF RELATED APPLICATION

This application claims the benefit of U.S. Provisional Application No. 63/632,205, filed on Apr. 10, 2024, which is incorporated herein in its entirety.

### TECHNICAL FIELD

The present disclosure generally relates to improving relevance sorting for reviews in a platform.

### BACKGROUND

Ranking methods of reviews on product detail pages (PDPs) for a commerce website may not provide helpful reviews for users. When relevant information is either excluded or ranked ineffectively, it can result in the best-matched listings being hidden from users. This can create a suboptimal search experience, as users may struggle to identify the listings that are truly the best fit for their needs and preferences.

### SUMMARY

Some embodiments of the present disclosure provide a computer-implemented method for relevance sorting for reviews. The method includes extracting, using a large language model (LLM), from a first natural language review of a property listed on a property reservation platform, a plurality of keywords; grouping, by performing a cluster analysis on a plurality of numerical representations, each numerical representation corresponding to a keyword in the plurality of keywords, the plurality of keywords into a plurality of topics; generating, using the plurality of topics, a comprehensiveness score of the first natural language review; generating an overall score of each of a plurality of natural language reviews of the property including the first natural language review of the property, the overall score of the first natural language review of the property comprising the comprehensiveness score; and displaying, in a display of the property on the property reservation platform, a subset of the plurality of natural language reviews of the property ranked according to the overall score of each natural language review in the plurality of natural language reviews.

Some embodiments of the present disclosure provide a non-transitory computer-readable medium storing a program for relevance sorting for reviews. The program, when executed by a computer, configures the computer to extract, using a large language model (LLM), from a first natural language review of a property listed on a property reservation platform, a plurality of keywords; group, by performing a cluster analysis on a plurality of numerical representations, each numerical representation corresponding to a keyword in the plurality of keywords, the plurality of keywords into a plurality of topics; generate, using the plurality of topics, a comprehensiveness score of the first natural language review; generate an overall score of each of a plurality of natural language reviews of the property including the first natural language review of the property, the overall score of the first natural language review of the property comprising the comprehensiveness score; and display, in a display of the property on the property reservation platform, a subset of the plurality of natural language reviews of the property ranked according to the overall score of each natural language review in the plurality of natural language reviews.

Some embodiments of the present disclosure provide a system for relevance sorting for reviews. The system comprises a processor and a non-transitory computer readable medium storing a set of instructions, which when executed by the processor, configure the processor to extract, using a large language model (LLM), from a first natural language review of a property listed on a property reservation platform, a plurality of keywords; group, by performing a cluster analysis on a plurality of numerical representations, each numerical representation corresponding to a keyword in the plurality of keywords, the plurality of keywords into a plurality of topics; generate, using the plurality of topics, a comprehensiveness score of the first natural language review; generate an overall score of each of a plurality of natural language reviews of the property including the first natural language review of the property, the overall score of the first natural language review of the property comprising the comprehensiveness score; and display, in a display of the property on the property reservation platform, a subset of the plurality of natural language reviews of the property ranked according to the overall score of each natural language review in the plurality of natural language reviews.

### BRIEF DESCRIPTION OF THE DRAWINGS

To easily identify the discussion of any particular element or act, the most significant digit or digits in a reference number refer to the figure number in which that element is first introduced.

FIG. 1 illustrates a network architecture used for implementing aspects of embodiments, as described herein.

FIG. 2 is a block diagram illustrating details of devices used in the architecture of FIG. 1, as described herein.

FIG. 3 is a block diagram illustrating a computer system used to at least partially carry out one or more of operations in methods disclosed herein, according to some embodiments.

FIG. 4 depicts a block diagram of an example configuration for relevance sorting for reviews, in accordance with an illustrative embodiment.

FIG. 5 depicts a flowchart of an example process for relevance sorting for reviews. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regards to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Reviews on a PDP review model may be, as a default, ranked by recency. This means, in many cases, helpful reviews will be buried down in the review's model. One use case for a PDP review model is a property reservation platform providing listing options for guests to reserve and pay for stays at one or more properties, such as hotel rooms, apartments, or houses, as guests often select a property based on other guests' reviews (hosted on the platform) of that property. Thus, there is a need to surface the most relevant information to users first, helping reduce review research effort and drive product sales or bookings to listings that are the best match for users. Embodiments of the present application address the above-described challenges by providing a relevance sort feature wherein sort options will show the highest quality and most relevant reviews first to guests (i.e., users) using a platform. Reviews showing may be prioritized on PDP according to one or more aspects of embodiments.

The relevance sort feature may prioritize displaying reviews based on one or more of:
Helpfulness: how helpful a review is considered. May be textual data.
Comprehensiveness: how comprehensive a review is. May be textual data.
Relevance: e.g., trip type, location, and language of the review being similar to the searcher.
Recency: Ensure that embodiments do not downrank more recent reviews.
Aligned with preferred outcomes: Ensure that ranking drives high quality stays.
Safety factor: a small percent of reviews could associate with safety related tickets and could highlight them.

### Ranking Model

Embodiments may combine a plurality of scores in order to determine overall review ranking, for example, one or more of helpfulness, comprehensiveness, relevance, and recency. The review ranking aims to provide representative reviews without biases (e.g., favoring or up-ranking of certain reviews).

Helpfulness: The helpfulness score may be generated by a machine learning (ML) model configured to predict review helpfulness.

The model may be tree-based (xgboost). The model may be initially trained on, for example, ~10 k English reviews. Analysis for non-English reviews may be done via translation. Review may include labels being a count of helpful words per review. A dataset of highlighted strings for reviews may be aggregated at the review level (i.e., count of helpful strings per review) and normalized by dividing by the review length.

Features (review attributes) may include, but are not limited to, grammar error rate, information density, recency, language, Term Frequency-Inverse Document Frequency (TF/IDF) score for review, content word count (i.e., verbs and nouns), length of review, and reviews with top search words/terms. Grammar error rate may be based on a count of the number of grammatical errors in a review string and normalized by word count. Information density may be measured based on the difficulty of a word and its proportionality to its surprisal (its negative log-probability) in the context within which it appears. A large language model (LLM) may be used to calculate the probabilities of different tokens (words) occurring in a sequence based on the previous tokens in the sequence. These probabilities give an idea of how likely it is for a specific word to be the next word in the sequence. Content word court, grammar error count, and information density may be normalized.

Guest/user attributes may include, but are not limited to, past reviews, wish lists, and searches within past reviews (filter search bar in review model).

Additional features may include, but are not limited to, non-static features (review had response from host or guest, past lifetime reviews of host (count/overall rating)), tag data (e.g., tags around the review content such as “dim_review_contains_wifi_information”), and review embeddings (e.g., using a Deep Learning model architecture or tree-based model).

In some implementations, the model is trained based on string-level model training (rather than aggregating at the id_review level, each helpful string is used in the training data). Any data within the review that has not been highlighted can be a separate row considered not helpful. In some implementations, the model is trained based on a review identified to contain helpful text. In this case, the label is whether the review contains any helpful information.

Comprehensiveness: An embodiment generates a comprehensiveness score of a review using one or more presently available machine learning models. If a review is in natural language form, an embodiment uses a presently available technique (e.g., by using an LLM) to extract one or more keywords from a natural language review of a property listed on a property reservation platform. An embodiment, by performing a cluster analysis on embeddings of extracted keywords, groups the keywords into a plurality of topics. Another embodiment uses another presently available technique to group the keywords into a plurality of topics. An embedding is a numerical representation corresponding to a keyword, generated using a trained model that assigns numerical representations based on semantic similarity of the item being represented by an embedding. As a result, embeddings of keywords that are more semantically similar to each other are closer together, in a vector space, than embeddings of keywords that are less semantically similar to each other. Using the topics, an embodiment generates a comprehensiveness score of the first natural language review. Because a review covering many topics is likely to be more comprehensive than a review covering only a few topics, one embodiment computes the comprehensiveness score of a review as a sum of the topics mentioned in the review. Because a review covering many topics that a user does not care about is not as helpful to a user as a review covering the same number of topics, but covering topics a user does care about, another embodiment computes the comprehensiveness score of a review as a weighted sum of the topics with each weight of a topic in the weighted sum determined by a predictiveness of that topic in predicting user satisfaction with the property. For example, if cleanliness is more predictive of user satisfaction with a property than whether a property has a hot tub, a review mentioning a property's cleanliness might have a higher comprehensiveness score than a review mentioning a property's hot tub. Some embodiments identify the predictiveness of a topic using a linear regression model, a presently available technique. Some embodiments assign a predefined weight to a topic, for example based on user surveys, user satisfaction data, or other user data.

One embodiment compares a sentiment expressed in a review to a sentiment expressed in other reviews of the same property. If a sentiment expressed in one review has more than a threshold amount of difference with a sentiment expressed in the other reviews, the embodiment adjusts the outlying review's comprehensiveness score downward, either as a component of the weighted sum or using another presently available technique.

Some embodiments generate a review's comprehensiveness score upon receipt of a review at the platform. Other embodiments generate a review's comprehensiveness score upon receipt of a sufficient number of other reviews of the same property, in response to a request for the display of the property on the property reservation platform, at predefined intervales (e.g., once per day), or triggered by another event.

Relevance: The relevance score is a simple heuristic that weights based on how many attributes the reviewer and the searcher have in common (personalized to searcher (e.g., pet friendly)). Some parameters we can include are:
Match, or degree or amount of matching, between an attribute of a reviewer providing the first natural language review and a user searching for the property:
   Country of origin of the review and searcher
   Language of review and searcher
   Family friendly (stay has infants or children)
   Has pets
   Group trip (e.g., 4+ guests)
   Long-term stays (e.g., 28+ nights)

An embodiment generates the relevance score of the first natural language review in response to a request for the display of the property on the property reservation platform.

Recency: The recency score gives more weight to more recent reviews than to older reviews. One embodiment generates a recency score of the first natural language review by comparing a first timestamp of the first natural language review with a second timestamp of a request for the display of the property on the property reservation platform.

Weights are determined and apply across the scores. This makes sure that the final ranking is aligned with desired outcomes. The weights may be determined by identifying which reviews are most predictive of the next trip being of high-quality using a linear regression model. This approach looks at the relationship between the components (i.e., scores) and driving trip quality. Weights may be static but vary on the search. The linear regression model may be trained as follows.

Data used: Sample of listings with PDP impressions and their reviews (except the latest review). Non-English reviews may be translated to English before the helpfulness score is computed. Review impressions may be retrieved using a sample query.

Label: Quality score of the most recent reviewed reservation.

### Controls:

Listing lifetime review count
Listing tenure
Reservation quality score
Features:
Helpfulness score
Relevance score components
   Country PDP search/reviewer match
   Language PDP search/reviewer match
   Family friendly PDP search/reviewer match
   Has pets PDP search/reviewer match
   Group trip PDP search/reviewer match
   Long-term stays PDP search/reviewer match
Review age in days (recency score)

The weights may be the coefficients of the interactions between the features and reservation quality score in the below Equation (1). Said otherwise, these coefficients capture the predictive value of the feature set beyond the reservation's quality score itself.

$$Helpfulness\_score * helpfulness\_weight + is\_country \_match * country\_weight … + review\_age * age\_weight \qquad Equation ( 1 )$$

In other embodiments, the weights may be the coefficients of the interactions between the features and reservation quality score in the below Equation (2).

$$comprehensiveness\_score * comprehensiveness\_weight + relevance\_score * relevance\_weight + recency\_score * recency\_weight \qquad Equation ( 2 )$$

In other embodiments, the weights may be the coefficients of the interactions between the features and reservation quality score in the below Equation (3).

$$comprehensiveness\_score * comprehensiveness\_weight + helpfulness\_score * helpfulness\_weight \_relevance \_score * relevance\_weight + recency\_score * recency\_weight \qquad Equation ( 3 )$$

According to some embodiments, PDP impressions may be determined without related searches. Majority (e.g., 80%) of PDP impressions come from search, but there will be at least some of impressions that will not have a relevance score. For this, embodiments include creating two versions of the weights: with and without the relevance score included.

### Implementation

A review index (e.g., Elasticsearch (ES)) may be used to consume and rank reviews based on the different scores.

For example, review sort architecture, according to embodiments, may leverage the review index to produce a sorted review list by prioritizing reviews with the user's language. A script score functionality may be used to provide the review index with a new script to determine a review's score/rank based on the review/reservation attributes and the user's search parameters at request time.

In some embodiments, a score may be set to the helpfulness score. If the languages match, the score may be boosted. Further, if a trip type matches (e.g., long term stay, short term stay, medium term stay), the score may be boosted again to generate a final score.

In some embodiments, a score may be set to the comprehensiveness score. If the languages match, the score may be boosted. Further, if a trip type matches (e.g., long term stay, short term stay, medium term stay), the score may be boosted again to generate a final score.

From the example, reviews that are deemed more helpful (based on an ML model helpfulness score) and match the user's language and are medium/long term stay would rank higher than those that do not. Reviews that have the same ranking score will be sorted by recency by default.

In some embodiments, the helpfulness score is computed daily based on the ML model and stored in a data table. An operating system consumes the helpfulness score and sink/integrated into the ES index.

In some embodiments, a review will not receive a helpfulness score immediately (e.g., until the daily job runs). If it is preferred to promote these new reviews, the reviews may be ranked with no helpfulness score higher than others.

In some embodiments, the comprehensiveness score is computed daily based on the ML model and stored in a data table. An operating system consumes the comprehensiveness score and sink/integrated into the ES index.

In some embodiments, a review will not receive a comprehensiveness score immediately (e.g., until the daily job runs). If it is preferred to promote these new reviews, the reviews may be ranked with no comprehensiveness score higher than others.

In some embodiments, the relevance score would be computed as part of the ES script. At the time of the PDP request, the backend will pass the user's relevant search parameters into the ES script to compute the relevance of a review.

In some embodiments, in the ES script, more weight is added to recent reviews (score 3) and can even boost reviews within a certain period (i.e., reviews within the last 2 years).

Some embodiments use highest-ranked reviews as training data when training a machine learning model to perform a task. Some embodiments use highest-ranked reviews to extract commonalities and generate guidance or coaching for a property owner or manager to improve aspects of a property. For example, if most of the highest-ranked reviews mention that a property is missing an amenity or a provided amenity does not meet reviewers' expectations, a property owner or manager might use this information to justify adding or upgrading the amenity.

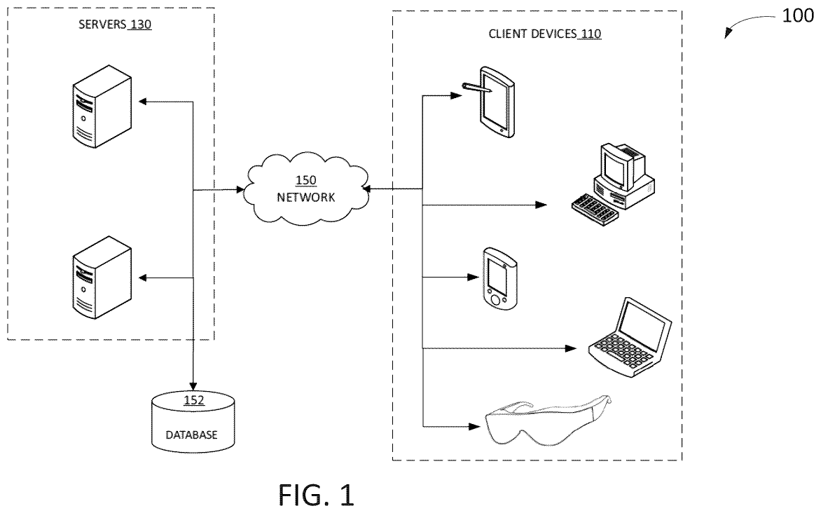

FIG. 1 illustrates a network architecture 100 used for implementing relevance sorting, according to some embodiments. Architecture 100 may include servers 130 and a database 152, communicatively coupled with multiple client devices 110 via a network 150. Client devices 110 may include any one of a laptop computer, a desktop computer, programmable device, or a mobile device such as a smart phone, a palm device, video player, or a tablet device. The database 152 may store backup files from, for example, matrices, videos, and processing data.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

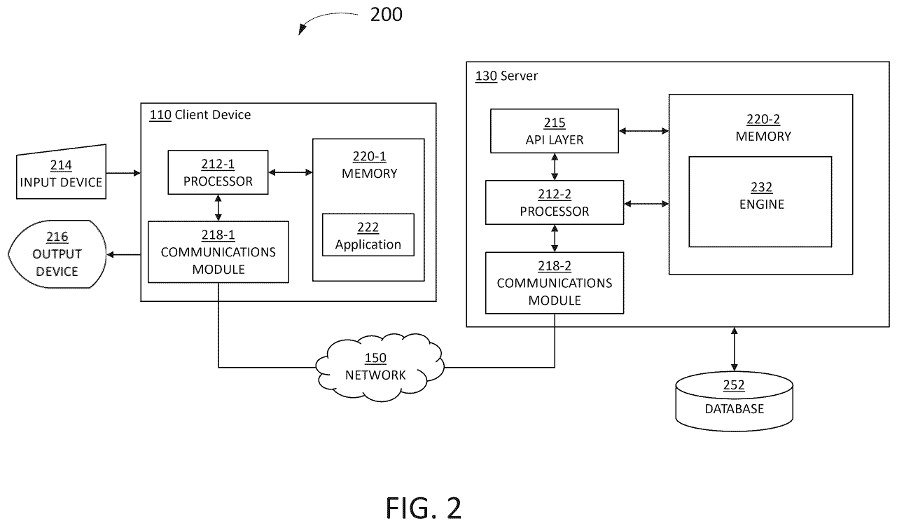

FIG. 2 is a block diagram 200 illustrating details of a client device 110 and a server 130 used in a network architecture as disclosed herein (e.g., architecture 100), according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency—RF—, near field communications—NFC—, Wi-Fi, and Bluetooth radio technology). Client device 110 may be coupled with an input device 214 and with an output device 216. A user may interact with client device 110 via the input device 214 and the output device 216. Input device 214 may include a mouse, a keyboard, a pointer, a touchscreen, a microphone, a joystick, a virtual joystick, a touchscreen display that a user may use to interact with client device 110, or the like. In some embodiments, input device 214 may include cameras, microphones, and sensors, such as touch sensors, acoustic sensors, inertial motion units—IMUs—and other sensors configured to provide input data to a client device. Output device 216 may be a screen display, a touchscreen, a speaker, and the like.

Client device 110 may also include a processor 212-1, configured to execute instructions stored in a memory 220-1, and to cause client device 110 to perform at least some operations in methods consistent with the present disclosure. Memory 220-1 may further include an application 222, configured to run in client device 110 and couple with input device 214 and output device 216. The application 222 may include specific instructions which, when executed by processor 212-1, cause operations to be performed according to methods described herein. Application 222 may receive data from the server 130 and may be hosted by the server 130. In some embodiments, the application 222 runs on an operating system (OS) installed in client device 110. In some embodiments, application 222 may run out of a web browser. In some embodiments, the processor is configured to control a graphical user interface (GUI) for the user of one of client devices 110 accessing the server 130.

A database 252 may store data and files (e.g., a data table) associated with the client device 110 and/or server 130. In some embodiments, client device 110 is a mobile phone used to initiate communication to another client device or server 130. Related data of the communication may be stored at the database 252.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an engine 232. The engine 232 may be configured to perform operations and methods according to aspects of embodiments. The engine 232 may share or provide features and resources with the client device, including multiple tools associated with the transfer or receipt of communications with engine 232 (e.g., application 222). The user may access engine 232 through application 222, installed in a memory 220-1 of client device 110. Accordingly, application 222 may be installed by server 130 and perform scripts and other routines provided by server 130 through any one of multiple tools. Execution of application 222 may be controlled by processor 212-1.

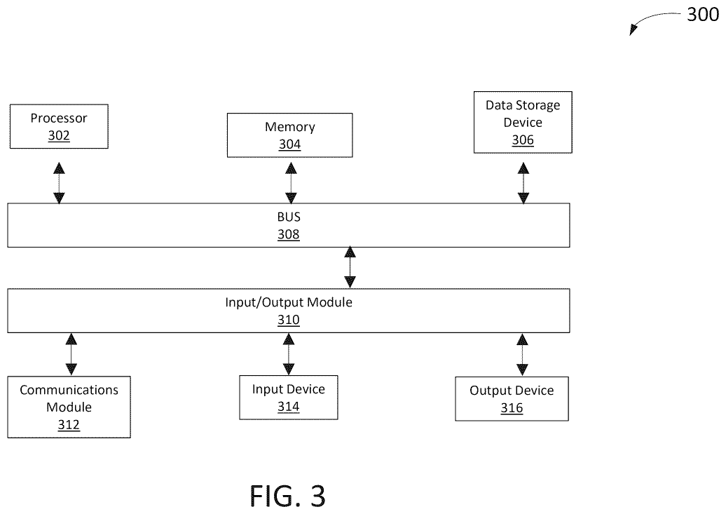

FIG. 3 is a block diagram illustrating an exemplary computer system 300 with which aspects of the subject technology can be implemented. In certain aspects, the computer system 300 may be implemented using hardware or a combination of software and hardware, either in a dedicated server, integrated into another entity, or distributed across multiple entities.

Computer system 300 (e.g., server and/or client) includes a bus 308 or other communication mechanism for communicating information, and a processor 302 coupled with bus 308 for processing information. By way of example, the computer system 300 may be implemented with one or more processors 302. Processor 302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 300 can include, in addition to hardware, code that creates an execution environment for the computer program in question, e.g., code that constitutes processor firmware, a protocol stack, a database management system, an operating system, or a combination of one or more of them stored in an included memory 304, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 308 for storing information and instructions to be executed by processor 302. The processor 302 and the memory 304 can be supplemented by, or incorporated in, special purpose logic circuitry.

The instructions may be stored in the memory 304 and implemented in one or more computer program products, i.e., one or more modules of computer program instructions encoded on a computer-readable medium for execution by, or to control the operation of, the computer system 300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 304 may also be used for storing temporary variable or other intermediate information during execution of instructions to be executed by processor 302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 300 further includes a data storage device 306 such as a magnetic disk or optical disk, coupled to bus 308 for storing information and instructions. Computer system 300 may be coupled via input/output module 310 to various devices. The input/output module 310 can be any input/output module. Exemplary input/output modules 310 include data ports such as USB ports. The input/output module 310 is configured to connect to a communications module 312. Exemplary communications modules 312 include networking interface cards, such as Ethernet cards and modems. In certain aspects, the input/output module 310 is configured to connect to a plurality of devices, such as an input device 314 and/or an output device 316. Exemplary input devices 314 include a keyboard and a pointing device, e.g., a mouse or a trackball, by which a user can provide input to the computer system 300. Other kinds of input devices 314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 316 include display devices such as an LCD (liquid crystal display) monitor, for displaying information to the user.

According to one aspect of the present disclosure, the above-described features can be implemented using a computer system 300 in response to processor 302 executing one or more sequences of one or more instructions contained in memory 304. Such instructions may be read into memory 304 from another machine-readable medium, such as data storage device 306. Execution of the sequences of instructions contained in the main memory 304 causes processor 302 to perform the process steps described herein. One or more processors in a multi-processing arrangement may also be employed to execute the sequences of instructions contained in memory 304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 300 can include clients and servers. A client and server are generally remote from each other and typically interact through a communication network. The relationship of client and server arises by virtue of computer programs running on the respective computers and having a client-server relationship to each other. Computer system 300 can be, for example, and without limitation, a desktop computer, laptop computer, or tablet computer. Computer system 300 can also be embedded in another device, for example, and without limitation, a mobile telephone, a PDA, a mobile audio player, a Global Positioning System (GPS) receiver, a video game console, and/or a television set top box.

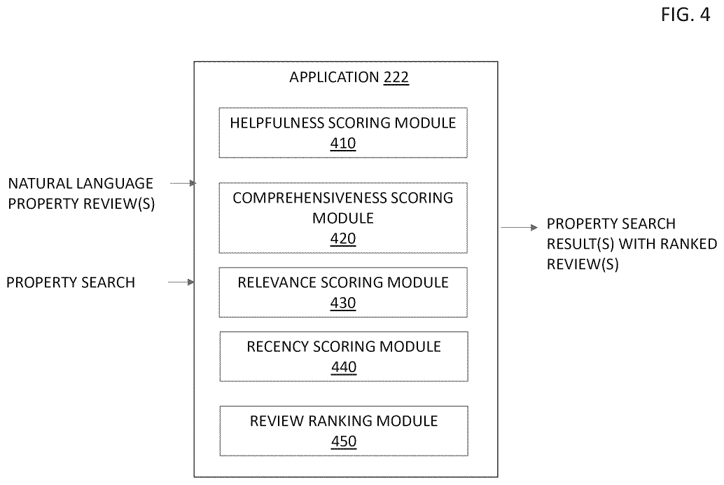

FIG. 4 depicts a block diagram of an example configuration for relevance sorting for reviews, in accordance with an illustrative embodiment. Application 222 is the same as application 222 in FIG. 2

Implementations of application 222 may combine a plurality of scores in order to determine overall review ranking, for example, one or more of helpfulness, comprehensiveness, relevance, and recency. The review ranking aims to provide representative reviews without biases (e.g., favoring or up-ranking of certain reviews).

Helpfulness: Helpfulness scoring module 410 generates a helpfulness score using a machine learning (ML) model configured to predict review helpfulness.

The model may be tree-based (xgboost). The model may be initially trained on, for example, ~10 k English reviews. Analysis for non-English reviews may be done via translation. Review may include labels being a count of helpful words per review. A dataset of highlighted strings for reviews may be aggregated at the review level (i.e., count of helpful strings per review) and normalized by dividing by the review length.

Features (review attributes) may include, but are not limited to, grammar error rate, information density, recency, language, Term Frequency-Inverse Document Frequency (TF/IDF) score for review, content word count (i.e., verbs and nouns), length of review, and reviews with top search words/terms. Grammar error rate may be based on a count of the number of grammatical errors in a review string and normalized by word count. Information density may be measured based on the difficulty of a word and its proportionality to its surprisal (its negative log-probability) in the context within which it appears. A large language model (LLM) may be used to calculate the probabilities of different tokens (words) occurring in a sequence based on the previous tokens in the sequence. These probabilities give an idea of how likely it is for a specific word to be the next word in the sequence. Content word court, grammar error count, and information density may be normalized.

Guest/user attributes may include, but are not limited to, past reviews, wish lists, and searches within past reviews (filter search bar in review model).

Additional features may include, but are not limited to, non-static features (review had response from host or guest, past lifetime reviews of host (count/overall rating)), tag data (e.g., tags around the review content such as “dim_review_contains_wifi_information”), and review embeddings (e.g., using a Deep Learning model architecture or tree-based model).

In some implementations of module 410, the model is trained based on string-level model training (rather than aggregating at the id_review level, each helpful string is used in the training data). Any data within the review that has not been highlighted can be a separate row considered not helpful. In some implementations, the model is trained based on a review identified to contain helpful text. In this case, the label is whether the review contains any helpful information.

Comprehensiveness: Comprehensiveness scoring module 420 generates a comprehensiveness score of a review using one or more presently available machine learning models. If a review is in natural language form, module 420 uses a presently available technique (e.g., by using an LLM) to extract one or more keywords from a natural language review of a property listed on a property reservation platform. Module 420, by performing a cluster analysis on embeddings of extracted keywords, groups the keywords into a plurality of topics. Another implementation of module 420 uses another presently available technique to group the keywords into a plurality of topics. An embedding is a numerical representation corresponding to a keyword, generated using a trained model that assigns numerical representations based on semantic similarity of the item being represented by an embedding. As a result, embeddings of keywords that are more semantically similar to each other are closer together, in a vector space, than embeddings of keywords that are less semantically similar to each other. Using the topics, module 420 generates a comprehensiveness score of the first natural language review. Because a review covering many topics is likely to be more comprehensive than a review covering only a few topics, one implementation of module 420 computes the comprehensiveness score of a review as a sum of the topics mentioned in the review. Because a review covering many topics that a user does not care about is not as helpful to a user as a review covering the same number of topics, but covering topics a user does care about, another implementation of module 420 computes the comprehensiveness score of a review as a weighted sum of the topics with each weight of a topic in the weighted sum determined by a predictiveness of that topic in predicting user satisfaction with the property. For example, if cleanliness is more predictive of user satisfaction with a property than whether a property has a hot tub, a review mentioning a property's cleanliness might have a higher comprehensiveness score than a review mentioning a property's hot tub. Some implementations of module 420 identify the predictiveness of a topic using a linear regression model, a presently available technique. Some implementations of module 420 assign a predefined weight to a topic, for example based on user surveys, user satisfaction data, or other user data.

One implementation of module 420 compares a sentiment expressed in a review to a sentiment expressed in other reviews of the same property. If a sentiment expressed in one review has more than a threshold amount of difference with a sentiment expressed in the other reviews, the implementation adjusts the outlying review's comprehensiveness score downward, either as a component of the weighted sum or using another presently available technique.

Some implementations of module 420 generate a review's comprehensiveness score upon receipt of a review at the platform. Other embodiments generate a review's comprehensiveness score upon receipt of a sufficient number of other reviews of the same property, in response to a request for the display of the property on the property reservation platform, at predefined intervales (e.g., once per day), or triggered by another event.

Relevance: Relevance scoring module 430 generates a relevance score using is a simple heuristic that weights based on how many attributes the reviewer and the searcher have in common (personalized to searcher (e.g., pet friendly)). Some non-limiting examples of parameters included in a relevance score are:
Match, or degree or amount of matching, between an attribute of a reviewer providing the first natural language review and a user searching for the property:
   Country of origin of the review and searcher
   Language of review and searcher
   Family friendly (stay has infants or children)
   Has pets
   Group trip (e.g., 4+ guests)
   Long-term stays (e.g., 28+ nights)

Some implementations of module 430 generate the relevance score of the first natural language review in response to a request for the display of the property on the property reservation platform.

Recency: Recency scoring module 440 generates a recency score giving more weight to more recent reviews than to older reviews. One implementation of module 440 generates a recency score of the first natural language review by comparing a first timestamp of the first natural language review with a second timestamp of a request for the display of the property on the property reservation platform.

In review ranking module 450, weights are determined and apply across the scores. This makes sure that the final ranking is aligned with desired outcomes. The weights may be determined by identifying which reviews are most predictive of the next trip being of high-quality using a linear regression model. This approach looks at the relationship between the components (i.e., scores) and driving trip quality. Weights may be static but vary on the search. The linear regression model may be trained as follows.

Data used: Sample of listings with PDP impressions and their reviews (except the latest review). Non-English reviews may be translated to English before the helpfulness score is computed. Review impressions may be retrieved using a sample query.

Label: Quality score of the most recent reviewed reservation.

### Controls:

Listing lifetime review count
Listing tenure
Reservation quality score
Features:
Helpfulness score
Relevance score components
   Country PDP search/reviewer match
   Language PDP search/reviewer match
   Family friendly PDP search/reviewer match
   Has pets PDP search/reviewer match
   Group trip PDP search/reviewer match
   Long-term stays PDP search/reviewer match
Review age in days (recency score)

The weights may be the coefficients of the interactions between the features and reservation quality score in Equation (1) described elsewhere herein. Said otherwise, these coefficients capture the predictive value of the feature set beyond the reservation's quality score itself.

In other implementation of module 450, the weights may be the coefficients of the interactions between the features and reservation quality score in Equation (2) described elsewhere herein.

In other embodiments, the weights may be the coefficients of the interactions between the features and reservation quality score in Equation (3) described elsewhere herein.

According to some implementations of module 450, PDP impressions may be determined without related searches. Majority (e.g., 80%) of PDP impressions come from search, but there will be at least some of impressions that will not have a relevance score. For this, implementations of module 450 include creating two versions of the weights: with and without the relevance score included.

### Implementation

A review index (e.g., Elasticsearch (ES)) may be used to consume and rank reviews based on the different scores.

For example, review sort architecture, according to implementations of application 222, may leverage the review index to produce a sorted review list by prioritizing reviews with the user's language. A script score functionality may be used to provide the review index with a new script to determine a review's score/rank based on the review/reservation attributes and the user's search parameters at request time.

In some implementations of application 222, a score may be set to the helpfulness score. If the languages match, the score may be boosted. Further, if a trip type matches (e.g., long term stay, short term stay, medium term stay), the score may be boosted again to generate a final score.

In some implementations of application 222, a score may be set to the comprehensiveness score. If the languages match, the score may be boosted. Further, if a trip type matches (e.g., long term stay, short term stay, medium term stay), the score may be boosted again to generate a final score.

From the example, reviews that are deemed more helpful (based on an ML model helpfulness score) and match the user's language and are medium/long term stay would rank higher than those that do not. Reviews that have the same ranking score will be sorted by recency by default.

In some implementations of application 222, the helpfulness score is computed daily based on the ML model and stored in a data table. An operating system consumes the helpfulness score and sink/integrated into the ES index.

In some implementations of application 222, a review will not receive a helpfulness score immediately (e.g., until the daily job runs). If it is preferred to promote these new reviews, the reviews may be ranked with no helpfulness score higher than others.

In some implementations of application 222, the comprehensiveness score is computed daily based on the ML model and stored in a data table. An operating system consumes the comprehensiveness score and sink/integrated into the ES index.

In some implementations of application 222, a review will not receive a comprehensiveness score immediately (e.g., until the daily job runs). If it is preferred to promote these new reviews, the reviews may be ranked with no comprehensiveness score higher than others.

In some implementations of application 222, the relevance score would be computed as part of the ES script. At the time of the PDP request, the backend will pass the user's relevant search parameters into the ES script to compute the relevance of a review.

In some implementations of application 222, in the ES script, more weight is added to recent reviews (score 3) and can even boost reviews within a certain period (i.e., reviews within the last 2 years).

Some implementations of application 222 use highest-ranked reviews as training data when training a machine learning model to perform a task. Some implementations of application 222 use highest-ranked reviews to extract commonalities and generate guidance or coaching for a property owner or manager to improve aspects of a property. For example, if most of the highest-ranked reviews mention that a property is missing an amenity or a provided amenity does not meet reviewers' expectations, a property owner or manager might use this information to justify adding or upgrading the amenity.

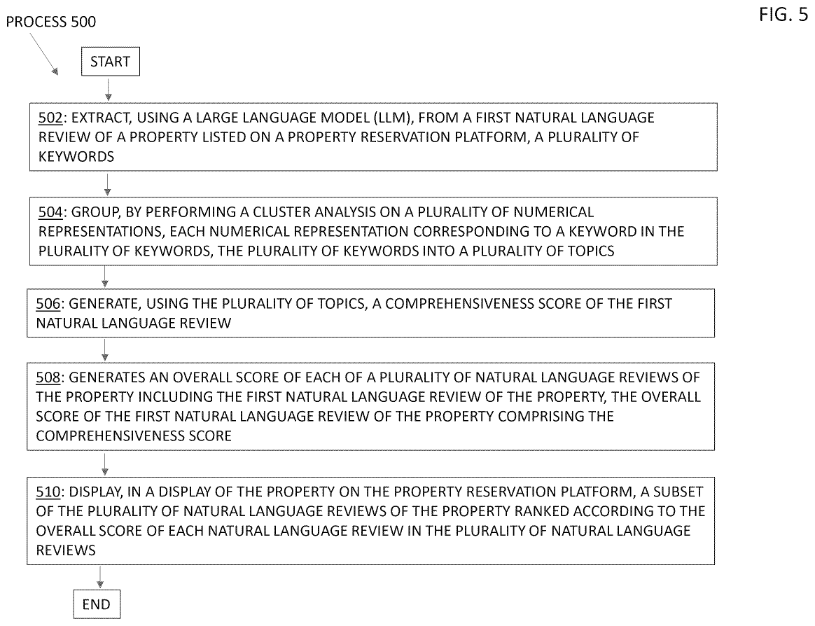

FIG. 5 depicts a flowchart of an example process for relevance sorting for reviews. in accordance with an illustrative embodiment. Process 500 can be executed using application 222 in FIG. 2.

At block 502, the process extracts, using a large language model (LLM), from a first natural language review of a property listed on a property reservation platform, a plurality of keywords. At block 504, the process groups, by performing a cluster analysis on a plurality of numerical representations, each numerical representation corresponding to a keyword in the plurality of keywords, the plurality of keywords into a plurality of topics. At block 506, the process generates, using the plurality of topics, a comprehensiveness score of the first natural language review. At block 508, the process generates an overall score of each of a plurality of natural language reviews of the property including the first natural language review of the property, the overall score of the first natural language review of the property comprising the comprehensiveness score. At block 510, the process displays, in a display of the property on the property reservation platform, a subset of the plurality of natural language reviews of the property ranked according to the overall score of each natural language review in the plurality of natural language reviews. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the included clauses. Moreover, nothing disclosed herein is intended to be dedicated to the public regardless of whether such disclosure is explicitly recited in the clauses. No clause element is to be construed under the provisions of 35 U.S.C. § 112 (f) unless the element is expressly recited using the phrase “means for” or, in the case of a method, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a clause.

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the clauses. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any clause. Rather, as the clauses reflect, inventive subject matter lies in less than all features of a single disclosed configuration or operation. The clauses are hereby incorporated into the Detailed Description, with each clause standing on its own to represent separately patentable subject matter.

Embodiments consistent with the present disclosure may be combined with any combination of features or aspects of embodiments described herein.

1. A computer-implemented method comprising:
extracting, using a large language model (LLM), from a first natural language review of a property listed on a property reservation platform, a plurality of keywords;
grouping, by performing a cluster analysis on a plurality of numerical representations, each numerical representation corresponding to a keyword in the plurality of keywords, the plurality of keywords into a plurality of topics;
generating, using the plurality of topics, a comprehensiveness score of the first natural language review, wherein the comprehensiveness score comprises a weighted sum of the plurality of topics, each weight of a topic in the weighted sum determined by a predictiveness of that topic in predicting user satisfaction with the property, the predictiveness identified using a first linear regression model;
generating an overall score of each of a plurality of natural language reviews of the property including the first natural language review of the property, the overall score of the first natural language review of the property comprising the comprehensiveness score; and
displaying, in a display of the property on the property reservation platform, a subset of the plurality of natural language reviews of the property ranked according to the overall score of each natural language review in the plurality of natural language reviews.

2. (canceled)

3. The computer-implemented method of claim 1, wherein the comprehensiveness score of the first natural language review is generated upon receipt of the first natural language review at the platform.

4. The computer-implemented method of claim 1, wherein the overall score comprises a helpfulness score generated by a machine learning model configured to predict review helpfulness, the machine learning model trained to predict review helpfulness from training data, the training data comprising a plurality of reviews in natural language text, each review in the plurality of reviews labelled with a count of helpful words in the review.

5. The computer-implemented method of claim 1, further comprising:
generating, by computing a weighted sum of a plurality of components, a relevance score of the first natural language review, wherein each component in the plurality of components of the relevance score comprises a degree of matching between an attribute of a reviewer providing the first natural language review and a user searching for the property on the property reservation platform.

6. The computer-implemented method of claim 5, wherein the relevance score of the first natural language review is generated in response to a request for the display of the property on the property reservation platform.

7. The computer-implemented method of claim 5, further comprising:
generating, by comparing a first timestamp of the first natural language review with a second timestamp of a request for the display of the property on the property reservation platform, a recency score of the first natural language review.

8. The computer-implemented method of claim 7, wherein the overall score of the first natural language review comprises a weighted sum of the comprehensiveness score of the first natural language review, the relevance score of the first natural language review, and the recency score of the first natural language review.

9. A non-transitory computer-readable medium storing a program, which when executed by a computer, configures the computer to:
extract, using a large language model (LLM), from a first natural language review of a property listed on a property reservation platform, a plurality of keywords;
group, by performing a cluster analysis on a plurality of numerical representations, each numerical representation corresponding to a keyword in the plurality of keywords, the plurality of keywords into a plurality of topics;
generate, using the plurality of topics, a comprehensiveness score of the first natural language review, wherein the comprehensiveness score comprises a weighted sum of the plurality of topics, each weight of a topic in the weighted sum determined by a predictiveness of that topic in predicting user satisfaction with the property, the predictiveness identified using a first linear regression model;
generate an overall score of each of a plurality of natural language reviews of the property including the first natural language review of the property, the overall score of the first natural language review of the property comprising the comprehensiveness score; and
display, in a display of the property on the property reservation platform, a subset of the plurality of natural language reviews of the property ranked according to the overall score of each natural language review in the plurality of natural language reviews.

10. (canceled)

11. The non-transitory computer-readable medium of claim 9, wherein the comprehensiveness score of the first natural language review is generated upon receipt of the first natural language review at the platform.

12. The non-transitory computer-readable medium of claim 9, wherein the overall score comprises a helpfulness score generated by a machine learning model configured to predict review helpfulness, the machine learning model trained to predict review helpfulness from training data, the training data comprising a plurality of reviews in natural language text, each review in the plurality of reviews labelled with a count of helpful words in the review.

13. The non-transitory computer-readable medium of claim 9, wherein the program, when executed by the computer, further configures the computer to:
generate, by computing a weighted sum of a plurality of components, a relevance score of the first natural language review, wherein each component in the plurality of components of the relevance score comprises a degree of matching between an attribute of a reviewer providing the first natural language review and a user searching for the property on the property reservation platform.

14. The non-transitory computer-readable medium of claim 13, wherein the relevance score of the first natural language review is generated in response to a request for the display of the property on the property reservation platform.

15. The non-transitory computer-readable medium of claim 13, wherein the program, when executed by the computer, further configures the computer to:
generate, by comparing a first timestamp of the first natural language review with a second timestamp of a request for the display of the property on the property reservation platform, a recency score of the first natural language review.

16. The non-transitory computer-readable medium of claim 15, wherein the overall score of the first natural language review comprises a weighted sum of the comprehensiveness score of the first natural language review, the relevance score of the first natural language review, and the recency score of the first natural language review.

17. A system comprising:
a processor; and
a non-transitory computer readable medium storing a set of instructions, which when executed by the processor, configure the system to:
extract, using a large language model (LLM), from a first natural language review of a property listed on a property reservation platform, a plurality of keywords;
group, by performing a cluster analysis on a plurality of numerical representations, each numerical representation corresponding to a keyword in the plurality of keywords, the plurality of keywords into a plurality of topics;
generate, using the plurality of topics, a comprehensiveness score of the first natural language review, wherein the comprehensiveness score comprises a weighted sum of the plurality of topics, each weight of a topic in the weighted sum determined by a predictiveness of that topic in predicting user satisfaction with the property, the predictiveness identified using a first linear regression model;
generate an overall score of each of a plurality of natural language reviews of the property including the first natural language review of the property, the overall score of the first natural language review of the property comprising the comprehensiveness score; and
display, in a display of the property on the property reservation platform, a subset of the plurality of natural language reviews of the property ranked according to the overall score of each natural language review in the plurality of natural language reviews.

18. (canceled)

19. The system of claim 17, wherein the comprehensiveness score of the first natural language review is generated upon receipt of the first natural language review at the platform.

20. The system of claim 17, wherein the overall score comprises a helpfulness score generated by a machine learning model configured to predict review helpfulness, the machine learning model trained to predict review helpfulness from training data, the training data comprising a plurality of reviews in natural language text, each review in the plurality of reviews labelled with a count of helpful words in the review.
